(19) United States
(12) Patent Application Publication
(10) Pub. No.: US 2004/0179893 A1
(43) Pub. Date: Sep. 16, 2004

(54) Transmitting system in scanner chassis

(76) Inventors: Nai-Ching Kuo, Gukeng Township (TW); Tse-Hui Pang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/618,879

(22) Filed: Jul. 14, 2003

(30) Foreign Application Priority Data
Mar. 13, 2003 (TW) 092203878

(51) Int. Cl. F16B 1/00

(52) U.S. Cl. 403/396

(57) ABSTRACT

An improved transmitting system in scanner chassis comprises a bushing rod and an integrated bushing. The bushing includes a first and a second spring strip set respectively disposed at both ends of the bushing for the purpose of clipping onto the bushing rod. The two spring strip sets both include a plurality of spring strips. During an assembling process of the transmitting system, the spring strips of the first and the second spring strip sets can be hold open to allow the bushing rod to pass through, and then the bushing clips to the bushing rod by the potential for the spring strips to return to their original position.

This application claims the benefit of Taiwan application Serial No. 92203878, filed Mar. 13, 2003.

### BACHGROUND OF THE INVENTION

1. Field of the Invention

The present invention relates to a transmitting system of a scanner chassis, and more specifically to an integrated single bushing equipped with a number of spring strips in the transmitting system.

2. Description of the Related Art

Scanners are widely used computer peripheral devices for capturing image and converting the document image to digital signals for computer process. Among a large number of competing products in the market, scanners have been improved in various functions and requirements such as high resolution, high image quality, and the like. But as for the transmitting system of the scanner chassis, it is still flawed in a number of ways.

FIG. 1 is a schematic diagram showing the typical transmitting system of a conventional scanner chassis. Referring to FIG. 1, the scanner chassis 100 has a transmitting system 110 and the transmitting system 110 primarily includes a bushing rod 112 and a busing 111 (generally made of metal). The bushing is coupled to the chassis 100 and also mounted in the bushing rod 112 so that the chassis 100 movably slide along the direction of X shown in FIG. 1.

FIG. 2A is an enlarged scale view of the transmitting system 110 in accordance with FIG. 1. The both ends of the bushing 111 are separately clogged with retainers 201 and 202. The retainers 201 and 202 function to clip onto the bushing rod 112, drive the chassis 100 to slide along the direction of X shown in FIG. 2A during scanning operation, and prevent the chassis 100 from moving or rotating along another directions.

Further, FIG. 2B is a schematic diagram illustrating a hook section 201 of the retainer 201 shown in FIG. 2A. Referring to FIG. 2B, the retainer 201 is ring-shaped whose hollow casing has a hook section 211 and the retainer 201 is engaged with the bushing 111 by the hook section 211. During an assembling process of the transmitting system, put the bushing 111 into the bushing rod 112 and then insert the retainers 201 and 202 into both ends of the bushing 111 separately. Via the hook section 211, the retainer 201 is engaged with the bushing 111 and clips onto the bushing rod 112 so that the chassis 100 slide movably only along the direction of X shown in FIG. 2A.

However, due to the three-piece configuration of a bushing in a conventional chassis transmitting system, it causes higher production cost such as the cost of manufacturing material, the cost of shaping module, and so on. The configuration of one bushing and two retainers becomes more complicated and further consumes more time during an assembling process of the transmitting system. Moreover, the concentricity imperfection between the bushing and the two retainers, or space generated when the bushing and the two retainers fit to each other, will cause negative impact and vibration for the chassis during scanning operation, which will lower scanning quality and making noise. All of this begs for improvement.

### SUMMARY OF THE INVENTION

In views of the aforesaid difficulties of the conventional techniques, the present invention provides a transmitting system that the integrated single bushing made of elastic materials overcoming the disadvantages and limitations of prior transmitting system in a scanner chassis.

It is therefore an object of the present invention to provide an improved transmitting system having a bushing rod and an integrated bushing. The bushing includes a first and a second spring strip set respectively disposed at both ends of the bushing for the purpose of clipping onto the bushing rod. The two spring strip sets both include a plurality of spring strips. During an assembling process of the transmitting system, the spring strips of the first and the second spring strip sets can be hold open to allow the bushing rod to pass through, and then the bushing clips to the bushing rod by the potential for the spring strips to return to their original position.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (prior art) is a schematic diagram of the transmitting system in a conventional scanner chassis;

FIG. 2A (prior art) is an enlarged scale view of the transmitting system in accordance with FIG. 1;

FIG. 2B (prior art) is a schematic diagram of the hook section in accordance with FIG. 2A;

FIG. 3A is a schematic diagram of the bushing according to a preferred embodiment of the invention; and

FIG. 3B is a lateral view of the bushing from the other side in accordance with FIG. 3A.

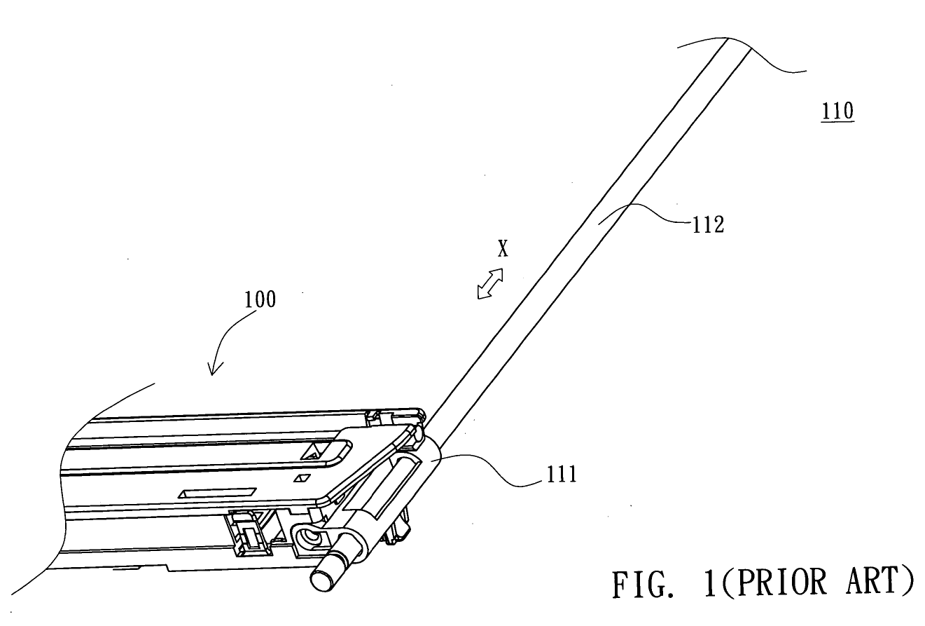

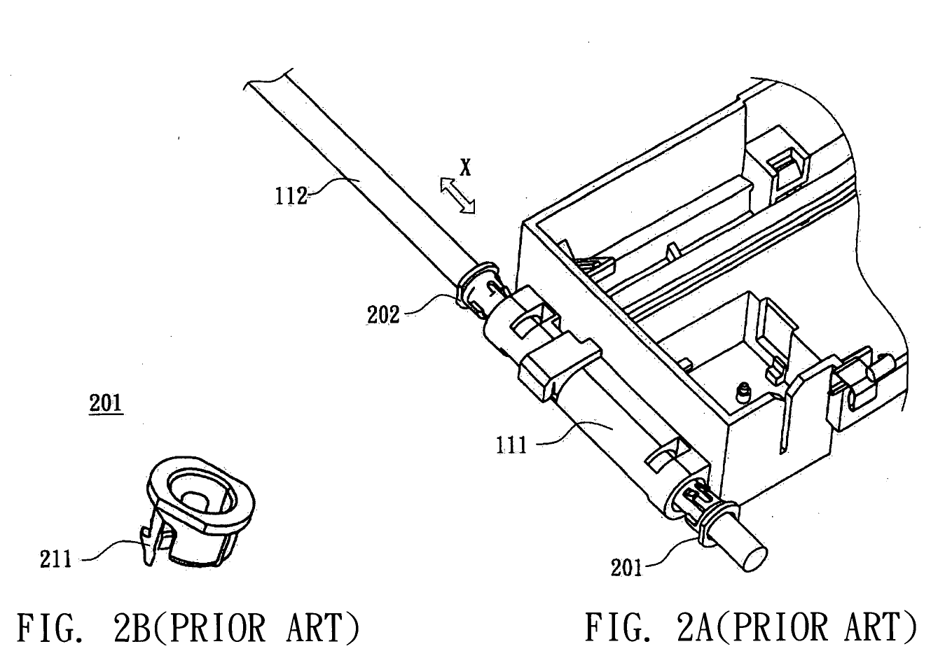

### DETAILED DESCRIPTION OF THE INVENTION

The present invention aims to ameliorate the conventional three-piece configuration bushing 111 by making an integrated and unified bushing 300. This integrated single device is desired not only to decrease the cost of production and save the assembly time, but also minimize such problems like the vibration of the chassis during scanning operation.

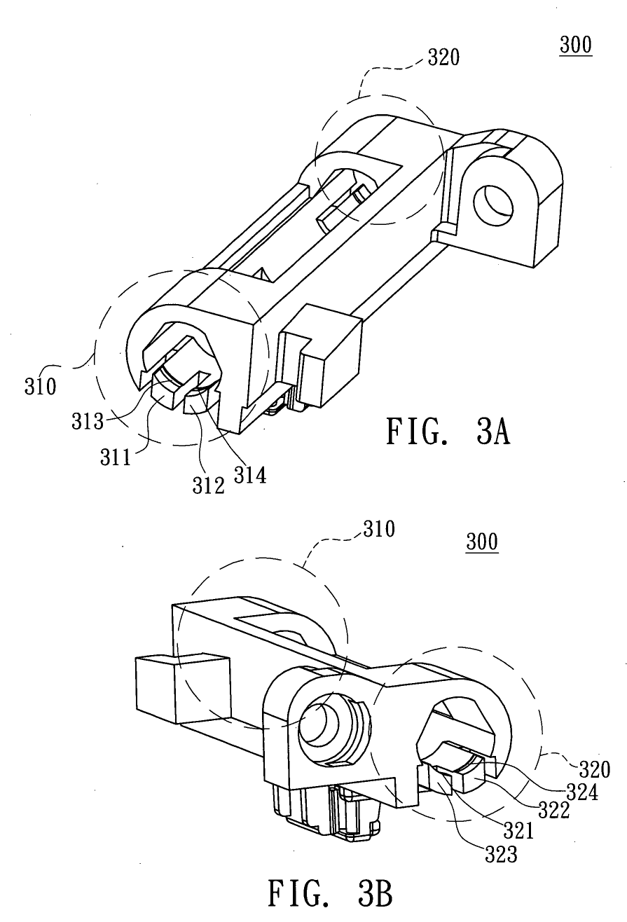

FIG. 3A is a schematic diagram of the improved bushing 300 according to a preferred embodiment of the invention. Referring to FIG. 3A, the integrated bushing 300 is made of elastic materials such as plastic; there are two spring strip sets 310 and 320 separately disposed at both ends of the bushing 300 for the purpose of clipping onto the bushing rod 112. The spring strip set 310 includes spring strips 311 and 312; there is a gap between the spring strips 311 and 312 so that the spring strip set 310 can be hold open and allows the busing rod 112 to pass through during the assembling process. Furthermore, there are flange 313 and flange 314 respectively deposed on the inner surface of the spring strip 311 and the spring strip 312 to strengthen the attachment of the bushing 300 and the bushing rod 112. FIG. 3B is a lateral view of the bushing 300, from the other side view. The spring strip set 320 includes spring strips 321 and 322; there is a gap between the spring strips 321 and 322 so that the spring strip set 320 can be hold open and allows the busing rod 112 to pass through during the assembling process. Furthermore, there are flange 323 and flange 324 respectively deposed on the inner surface of the spring strip 321 and the spring strip 322 to strengthen the attachment of the bushing 300 and the bushing rod 112.

During an assembling process of the transmitting system, the spring strip sets 310 and 320 can be hold open to allow the bushing rod 112 to pass through, and then the bushing 300 clips onto the bushing rod 112 by the potential for the spring strips 311, 312, 321, and 322 to return to their original position.

In summary, this integrated bushing of the transmitting system in a scanner chassis of the present invention at least offers the following advantages:

a. The integrated single configuration of the bushing has less devices than the conventional three-pieces configuration of the bushing. This measure will help decrease the production cost such as the cost of manufacturing materials, and the cost of shaping module.

b. The single configuration of the bushing is easier in assembling, compared to the conventional three-piece configuration and the gaps between the spring strips simplify the assembly of interference fit or close fit.

c. The concentricity imperfection of the conventional three-piece configuration between the bushing and the two retainers or space generated between different devices fit to each other will cause negative impact and vibration for the chassis during scanning operation. The improved single configuration of the bushing resolves the above-mentioned problems and the flanges deposed on the inner surface of the spring strips help the bushing and bushing rod join together more closely.

While the invention has been described by a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A transmitting system in a scanner chassis comprising a bushing rod and a bushing, wherein the bushing comprises:
a first spring strip set deposed in one end of the bushing, wherein the first spring strip set comprises a plurality of spring strips which function to clip onto the bushing rod; and
a second spring strip set deposed in the other end of the bushing, wherein the second spring strip set comprises a plurality of spring strips which function to clip onto the bushing rod,
wherein during an assembling process of the transmitting system, the spring strips of the first and the second spring strip sets can be hold open to allow the bushing rod to pass through, and then the bushing clips to the bushing rod by the potential for the spring strips to return to their original position.

2. The transmitting system according to claim 1, wherein the bushing is an integrated single device.

3. The transmitting system according to claim 1, wherein there are gaps disposed between the spring strips permitting the spring strips to be hold open and allows the busing rod to pass through during the assembling process.

4. The transmitting system according to claim 1, wherein there is a flange disposed on the inner surface of the spring strips, strengthening the attachment of the bushing and the bushing rod.

5. The transmitting system according to claim 4, wherein the flange is ring-shaped.

6. The transmitting system according to claim 1, wherein the bushing rod and the bushing are attached by interference fit.

7. The transmitting system according to claim 1, wherein the bushing rod and the bushing are attached by close fit.

8. The transmitting system according to claim 1, wherein the bushing is made of an elastic material.

9. The transmitting system according to claim 8, wherein the elastic material is plastic.

10. The transmitting system according to claim 1, wherein the bushing rod is made of metal.

11. A scanner, comprising:
a transmitting system comprising a bushing rod and a bushing, wherein the bushing comprises a first spring strip set and a second spring strip set,
wherein the first spring strip set is deposed in one end of the bushing comprising a plurality of spring strips; the spring strips function to clip onto the bushing rod; and the second spring strip set is deposed in the other end of the bushing comprising a plurality of spring strips; the spring strips function to clip onto the bushing rod,
wherein during an assembling process of the transmitting system, the spring strips of the first and the second spring strip sets can be hold open to allow the bushing rod to pass through, and then the bushing clips to the bushing rod by the potential for the spring strips to return to their original position.

12. The transmitting system according to claim 11, wherein the bushing is an integrated single device.

13. The transmitting system according to claim 11, wherein there are gaps disposed between the spring strips permitting the spring strips to be hold open and allows the busing rod to pass through during the assembling process.

14. The transmitting system according to claim 11, wherein there is a flange disposed on the inner surface of the spring strips, strengthening the attachment of the bushing and the bushing rod.

15. The transmitting system according to claim 14, wherein the flange is ring-shaped.

16. The transmitting system according to claim 11, wherein the bushing rod and the bushing are attached by interference fit.

17. The transmitting system according to claim 11, wherein the bushing rod and the bushing are attached by close fit.

18. The transmitting system according to claim 11, wherein the bushing is made of an elastic material.

19. The transmitting system according to claim 18, wherein the elastic material is plastic.

20. The transmitting system according to claim 11, wherein the bushing rod is made of metal.
